(19) United States
(12) Patent Application Publication
(10) Pub. No.: US 2026/0178456 A1
(43) Pub. Date: Jun. 25, 2026

(54) SWITCHING BETWEEN WRITE JOURNALING MODES FOR A HIGH-AVAILABILITY STORAGE SYSTEM CONFIGURATION FOR FAILBACK SCENARIOS

(71) Applicant: NetApp, Inc., San Jose, CA (US)

(72) Inventors: Joseph Brown, JR., Raleigh, NC (US); Javier Tsuyoshi Takimoto, Johns Creek, GA (US); Michael Scott Ryan, Wake Forest, NC (US)

(73) Assignee: NetApp, Inc., San Jose, CA (US)

(21) Appl. No.: 19/281,159

(22) Filed: Jul. 25, 2025

Related U.S. Application Data
(60) Provisional application No. 63/737,464, filed on Dec. 20, 2024.
(60) Provisional application No. 63/832,941, filed on Jun. 30, 2025.

(51) Int. Cl. G06F 11/20

(52) U.S. Cl. CPC G06F 11/2092; G06F 11/2064; G06F 2201/855

(57) ABSTRACT

Systems and methods for performing journal swapping are provided. In one example, the backing storage used for virtual non-volatile random access memory (vNVRAM) is dynamically switched based on the high-availability (HA) state of an HA pair of nodes of a virtual storage system. By default, in-memory logging may be used for write journaling when the HA pair is operating in a normal HA state. When the HA pair is in an HA degraded state, the write journaling may be performed to local ephemeral storage. This allows the file system of the virtual storage system to run in a more performant configuration most of the time (e.g., during which HA is enabled and healthy). At the same time, the file system has the ability to swap to a less performant but more resilient configuration during planned events (e.g., scheduled maintenance and throughput scaling) in which HA is in a degraded state.

### CROSS-REFERENCE TO RELATED APPLICATIONS

This application claims the benefit of priority of U.S. Provisional Application No. 63/737,464, filed on Dec. 20, 2024 and U.S. Provisional Application No. 63/832,941, filed on Jun. 30, 2025, both of which are hereby incorporated by reference in their entirety for all purposes.

### BACKGROUND

### Field

Various embodiments of the present disclosure generally relate to virtual storage systems. In particular, some embodiments relate to an approach for performing journal swapping (e.g., dynamically switching the backing storage used for write journaling) based on the high-availability (HA) state of an HA pair.

### Description of the Related Art

When a file system of a storage system, such as a storage server computing device, receives a write request, it commits the data to permanent storage before the request is confirmed to the writer. Otherwise, if the storage system were to experience a failure with data only in volatile memory, that data would be lost, and underlying file structures could become corrupted. Physical storage appliances commonly use battery-backed high-speed non-volatile random access memory (NVRAM) as a journaling storage media to journal writes and accelerate write performance while providing permanence, because writing to memory is much faster than writing to storage (e.g., disk). Storage systems may also implement a buffer cache in the form of an in-memory cache to cache data that is read from data storage media (e.g., local mass storage devices or a storage array associated with the storage system) as well as data modified by write requests. In this manner, in the event a subsequent access relates to data residing within the buffer cache, the data can be served from local, high performance, low latency storage, thereby improving overall performance of the storage system. The modified data may be periodically (e.g., every few seconds) flushed to the data storage media. As the buffer cache is limited in size, an additional cache level may be provided by a victim cache, typically implemented within a slower memory or storage device than utilized by the buffer cache, that stores data evicted from the buffer cache.

The event of saving the modified data to the mass storage devices may be referred to as a consistency point (CP). At a CP point, the file system may save any data that was modified by write requests to persistent data storage media. When operating in high-availability (HA) mode, the CP point may also trigger a process of updating the mirrored data (including at least the journal) stored at an HA partner. As will be appreciated, when using a buffer cache, there is a small risk of a system failure occurring between CPs, causing the loss of data modified after the last CP. Consequently, the storage system may maintain an operation log or journal of certain storage operations within the journaling storage media that have been performed since the last CP. This log may include a separate journal entry (e.g., including an operation header) for each storage request received from a client that results in a modification to the file system or data. Such entries for a given file may include, for example, “Create File,” “Write File Data,” and the like. Depending upon the operating mode or configuration of the storage system, each journal entry may also include the data to be written according to the corresponding request. The journal may be used in the event of a failure to recover data that would otherwise be lost. For example, in the event of a failure, it may be possible to replay the journal to reconstruct the current state of stored data just prior to the failure.

When a storage system is hosted in a cloud environment, the storage system may be referred to as a virtual storage system. In cloud environments, there is no availability of non-volatile memory or persistent storage having the performance characteristics of NVRAM so the backing storage for performing write journaling (which may also be referred to as NVlogging) is typically either a local solid-state drive (SSD) of the host on which the virtual storage system is operating or a hyperscale disk (e.g., Amazon Elastic Block Store (EBS)) supplied by the cloud provider.

### SUMMARY

Systems and methods are described for performing journal swapping. According to one embodiment, a surviving node of a high-availability (HA) pair of multiple nodes of a cluster of virtual storage systems receives an indication of imminent return of a recovering HA partner of the surviving node to a healthy HA operational state. After receipt of the indication, a file system of the surviving node is caused to transition from a first write mode in which journaling is performed to ephemeral storage associated with a host on which the surviving node is running to a second write mode in which write journaling is performed to ephemeral memory of the host.

Other features of embodiments of the present disclosure will be apparent from accompanying drawings and detailed description that follows.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 is a block diagram illustrating an environment in which various embodiments may be implemented.

FIG. 2 is a block diagram conceptually illustrating a host of a cloud environment in accordance with an embodiment of the present disclosure

FIG. 3 is a high-level conceptual block diagram illustrating an HA pair of a storage cluster in accordance with an embodiment of the present disclosure.

FIG. 4 is a flow diagram illustrating operations for performing journaling module initialization in accordance with an embodiment of the present disclosure.

FIG. 5 is a flow diagram illustrating operations for performing a write mode transition in accordance with an embodiment of the present disclosure.

FIG. 6 is a flow diagram illustrating operations for switching a write mode from high write speed (HWS) ephemeral memory to HWS ephemeral storage in accordance with an embodiment of the present disclosure.

FIG. 7 is a flow diagram illustrating operations associated with a planned failover (takeover) hook included an HA messaging service in accordance with an embodiment of the present disclosure.

FIG. 8 is a flow diagram illustrating operations associated with a failback (giveback) hook included an HA messaging service in accordance with an embodiment of the present disclosure.

FIG. 9 illustrates an example computer system in which or with which embodiments of the present disclosure may be utilized.

### DETAILED DESCRIPTION

Systems and methods are described for performing journal swapping. As noted above, a virtual storage system does not have access to non-volatile memory or persistent storage having similar performance characteristics as NVRAM for use in connection with performing operation log journaling (which may be referred to as “write journaling” or simply as “journaling” herein). As such, at present, a file system of a virtual storage system, depending upon the nature of the workloads expected to be supported and/or the configuration of the system, may instead rely on one of various options:
a first option in which persistent storage (e.g., a network attached storage device) provided by a hyperscaler (e.g., a cloud service provider) in which the virtual storage system is running is used as the journaling storage medium (which may be referred to herein as “virtual NVRAM” storage or “vNVRAM” storage as traditionally in a physical storage system NVRAM is used as the journaling storage media);
a second option in which an ephemeral memory (e.g., a portion of system memory or random access memory RAM) of the host that is available to the compute instance (e.g., virtual machine (VM) or container) in which the virtual storage system is running is used as the journaling storage medium; or
a third option in which ephemeral storage (e.g., an internal or local storage device of the host or a storage device directly attached to the host).

Various tradeoffs exist between performance and data durability (e.g., the ability to keep the stored data consistent) depending on the nature of the journaling storage media and other factors as discussed below. Relatively higher durability may be achieved by using persistent storage as the journaling storage media (the first option above) but at the cost of lower write speeds. Alternatively, relatively higher write speeds may be achieved when making use of ephemeral memory as the journaling storage media (the second option above); however, this comes with relatively lower durability as any data stored in ephemeral memory is lost when a host failure causes the compute instance to go down and the compute instance is rehosted on another host.

Also affecting the tradeoffs between performance and data durability are the various characteristics of the HA configuration employed by the cloud service provider for managing a cluster of virtual storage systems. Cloud service providers may maintain data centers in multiple geographic regions and each region may include distinct locations or availability zones (AZs) within each region that are engineered to be isolated from failures in other AZs. When HA partner virtual storage systems are deployed within the same AZ, which may be referred to herein as a “Single-AZ HA Configuration” or a “SAZ HA Configuration”), latency is low due to intra-AZ communications but there is a much greater probability of both virtual storage systems going down simultaneously than when HA partner virtual storage systems are deployed in different AZs of the same region, which may be referred to herein as a “Multi-AZ HA Configuration”). To be conservative, at present, virtual storage systems generally use a high-durability mode (HDM), which may be referred to herein as a high write speed (HWS) ephemeral storage write mode for write journaling when operating in a Single-AZ HA Configuration in which journaling is performed to vNVRAM backed by local SSD or a hyperscale disk (both of which result in low throughput as compared to journaling to memory). This in turn impacts write performance as acknowledgement by the storage system to a client of a given write request issued by the client is delayed until the journaling has been completed, thereby throttling the rate at which new write requests may be issued by the client.

In order to improve performance in Single-AZ HA Configurations, embodiments described herein propose dynamically switching the backing storage used for vNVRAM based on the HA state of the virtual storage system HA pair. In one embodiment, by default, in-memory logging (which may also be referred to herein as a high write speed ephemeral memory write mode) is used for write journaling when the HA pair is operating in a normal (or operational) HA state (e.g., HA is enabled and healthy). That is, system memory of the host on which the virtual storage system is running serves as the backing storage for the vNVRAM containing the journal. When the HA pair is in an HA degraded state, for example, in which only one virtual storage system of the HA pair is active, HA is not enabled, or HA is not healthy (e.g., mirroring is inactive), the write journaling is performed to ephemeral storage (e.g., local SSD or direct-attached SSD) or a hyperscale disk. In this manner, the file system of the virtual storage system at issue runs in a more performant configuration most of the time during which both virtual storage systems of the HA pair are active and in a healthy HA operational state. At the same time, the file system has the ability to swap to a less performant but more resilient configuration during scheduled maintenance and throughput scaling in which one of the virtual storage systems is inactive.

While various examples may be described herein with reference to performing journal swapping to accommodate for planned events (e.g., scheduled maintenance and/or throughput scaling), it is to be appreciated the methodologies described herein are equally applicable to unplanned events (e.g., a virtual machine panic or a kernel panic).

In the following description, numerous specific details are set forth in order to provide a thorough understanding of embodiments of the present disclosure. It will be apparent, however, to one skilled in the art that embodiments of the present disclosure may be practiced without some of these specific details. In other instances, well-known structures and devices are shown in block diagram form.

### Terminology

Brief definitions of terms used throughout this application are given below.

A “computer” or “computer system” may be one or more physical computers, virtual computers, or computing devices. As an example, a computer may be one or more server computers, cloud-based computers, cloud-based cluster of computers, virtual machine instances or virtual machine computing elements such as virtual processors, storage and memory, data centers, storage devices, desktop computers, laptop computers, mobile devices, or any other special-purpose computing devices. Any reference to “a computer” or “a computer system” herein may mean one or more computers, unless expressly stated otherwise.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

The terms “component”, “module”, “service,” “system,” and the like as used herein are intended to refer to a computer-related entity, either software-executing general-purpose processor, hardware, firmware and a combination thereof. For example, a component may be, but is not limited to being, a process running on a hardware processor, a hardware processor, an object, an executable, a thread of execution, a program, and/or a computer. By way of illustration, both an application running on a server and the server can be a component. One or more components may reside within a process and/or thread of execution, and a component may be localized on one computer and/or distributed between two or more computers. Also, these components can be executed from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

As used herein a “cloud” or “cloud environment” broadly and generally refers to a platform through which cloud computing may be delivered via a public network (e.g., the Internet) and/or a private network. The National Institute of Standards and Technology (NIST) defines cloud computing as “a model for enabling ubiquitous, convenient, on-demand network access to a shared pool of configurable computing resources (e.g., networks, servers, storage, applications, and services) that can be rapidly provisioned and released with minimal management effort or service provider interaction.” P. Mell, T. Grance, The NIST Definition of Cloud Computing, National Institute of Standards and Technology, USA, 2011. The infrastructure of a cloud may cloud may be deployed in accordance with various deployment models, including private cloud, community cloud, public cloud, and hybrid cloud. In the private cloud deployment model, the cloud infrastructure is provisioned for exclusive use by a single organization comprising multiple consumers (e.g., business units), may be owned, managed, and operated by the organization, a third party, or some combination of them, and may exist on or off premises. In the community cloud deployment model, the cloud infrastructure is provisioned for exclusive use by a specific community of consumers from organizations that have shared concerns (e.g., mission, security requirements, policy, and compliance considerations), may be owned, managed, and operated by one or more of the organizations in the community, a third party, or some combination of them, and may exist on or off premises. In the public cloud deployment model, the cloud infrastructure is provisioned for open use by the general public, may be owned, managed, and operated by a cloud provider (e.g., a business, academic, or government organization, or some combination of them), and exists on the premises of the cloud provider. The cloud service provider may offer a cloud-based platform, infrastructure, application, or storage services as-a-service, in accordance with a number of service models, including Software-as-a-Service (SaaS), Platform-as-a-Service (PaaS), and/or Infrastructure-as-a-Service (IaaS). In the hybrid cloud deployment model, the cloud infrastructure is a composition of two or more distinct cloud infrastructures (private, community, or public) that remain unique entities, but are bound together by standardized or proprietary technology that enables data and application portability (e.g., cloud bursting for load balancing between clouds).

As used herein “ephemeral storage” or an “ephemeral disk” generally refers to volatile temporary storage that is physically attached to the same host on which a compute instance is running and which is present during the running lifetime of the compute instance. For example, ephemeral storage may represent one or more internal or external hard-disk drives (HDDs and/or solid-state drives (SSDs) of the physical host that are directly attached (i.e., without going through one or more intermediate devices of a network) to the physical host though an interface (e.g., Small Computer System Interface (SCSI), Serial Advanced Technology Attachment (SATA), Serial-Attached SCSI (SAS), FC or Internet SCSI (iSCSI)). Ephemeral storage is not networked. That is, there are no connections through Ethernet or FC switches as is the case for network-attached storage (NAS) or a storage area network (SAN). Non-limiting examples of ephemeral storage include an Elastic Compute Cloud (EC2) instance store in the context of Amazon Web Services (AWS), an ephemeral operating system (OS) disk in the context of Microsoft Azure, and ephemeral disks (local SSD) in the context of Google Cloud Platform (GCP). As noted above, in the event a compute instance goes down due to an underlying recoverable host error, it is assumed herein that the cloud service provider will bring up the compute instance on the same host, thereby maintaining access to data (e.g., an operation log or journal) stored or otherwise flushed to the ephemeral storage by a virtual storage system associated with the compute instance.

As used herein “virtual NVRAM” or “vNVRAM” generally refers to a storage or memory in which a non-volatile (NV) operation log or journal is maintained during runtime of the virtual storage system. Depending upon the particular implementation the journal may be maintained within local memory (e.g., RAM) of the host on which the compute instance is running that contains the virtual storage system or may be maintained within ephemeral storage (e.g., a local SSD) or a hyperscale disk.

As used herein an “operation log,” a “journal,” an “NV operation log” or the like generally refers to a data structure in which journal entries, for example, including metadata (e.g., headers) of I/O operations and potentially data associated with the I/O operations are stored. As noted above, the journal may include metadata and/or data regarding certain storage operations that have been performed since the last CP to facilitate recovery, for example, from a system failure. For example, the journal may be used to facilitate performance of vNVRAM (or NV log or operation log) replay to recover data, facilitate maintaining data synchronization between HA partners and/or returning to a healthy HA operational state or HA mode after one of the HA partners recovers from a failure.

### Example Operating Environment

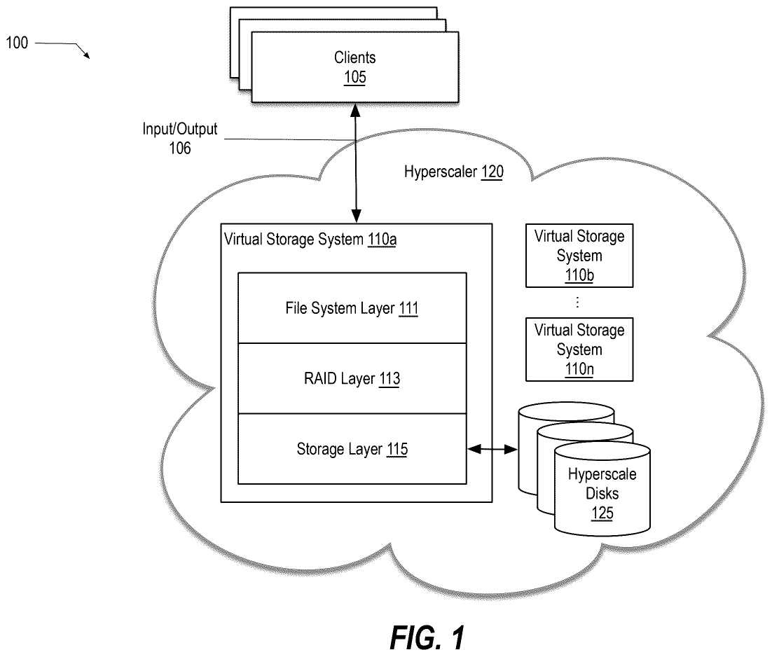

FIG. 1 is a block diagram illustrating an environment 100 in which various embodiments may be implemented. In various examples described herein, a virtual storage system 110a (which may be considered exemplary of individual virtual storage systems 110a-n operating as a cluster and collectively representing a distributed storage system) may be run (e.g., on a VM or as a containerized instance, as the case may be) within a public cloud provided by a public cloud provider (e.g., hyperscaler 120). In the context of the present example, the virtual storage system 110a makes use of storage (e.g., hyperscale disks 125) provided by the hyperscaler, for example, in the form of solid-state drive (SSD) backed or hard-disk drive (HDD) backed disks. The cloud disks (which may also be referred to herein as cloud volumes, storage devices, or simply volumes or storage) may include persistent storage (e.g., disks) and/or ephemeral storage (e.g., disks).

The virtual storage system 110a may present storage over a network to clients 105 using various protocols (e.g., small computer system interface (SCSI), Internet small computer system interface (ISCSI), fibre channel (FC), common Internet file system (CIFS), network file system (NFS), hypertext transfer protocol (HTTP), web-based distributed authoring and versioning (WebDAV), or a custom protocol. Clients 105 may request services of the virtual storage system 110 by issuing Input/Output requests 106 (e.g., file system protocol messages (in the form of packets) over the network). A representative client of clients 105 may comprise an application, such as a database application, executing on a computer that “connects” to the virtual storage system 110 over a computer network, such as a point-to-point link, a shared local area network (LAN), a wide area network (WAN), or a virtual private network (VPN) implemented over a public network, such as the Internet.

In the context of the present example, the virtual storage system 110a is shown including a number of layers, including a file system layer 111 and one or more intermediate storage layers (e.g., a RAID layer 113 and a storage layer 115). These layers may represent components of data management software (not shown) of the virtual storage system 110. The file system layer 111 generally defines the basic interfaces and data structures in support of file system operations (e.g., initialization, mounting, unmounting, creating files, creating directories, opening files, writing to files, and reading from files). A non-limiting example of a file system that may implement the file system layer 111 is the Write Anywhere File Layout (WAFL® file system), which represents a Copy-on-Write file system. The WAFL® file system is a component or layer of ONTAP® software available from NetApp, Inc. of San Jose, CA.

The RAID layer 113 may be responsible for encapsulating data storage virtualization technology for combining multiple hyperscale disks 125 into RAID groups, for example, for purposes of data redundancy, performance improvement, or both. The storage layer 115 may include storage drivers for interacting with the various types of hyperscale disks 125 supported by the hyperscaler 120. Depending upon the particular implementation the file system layer 111 may persist data to the hyperscale disks 125 using one or both of the RAID layer 113 and the storage layer 115.

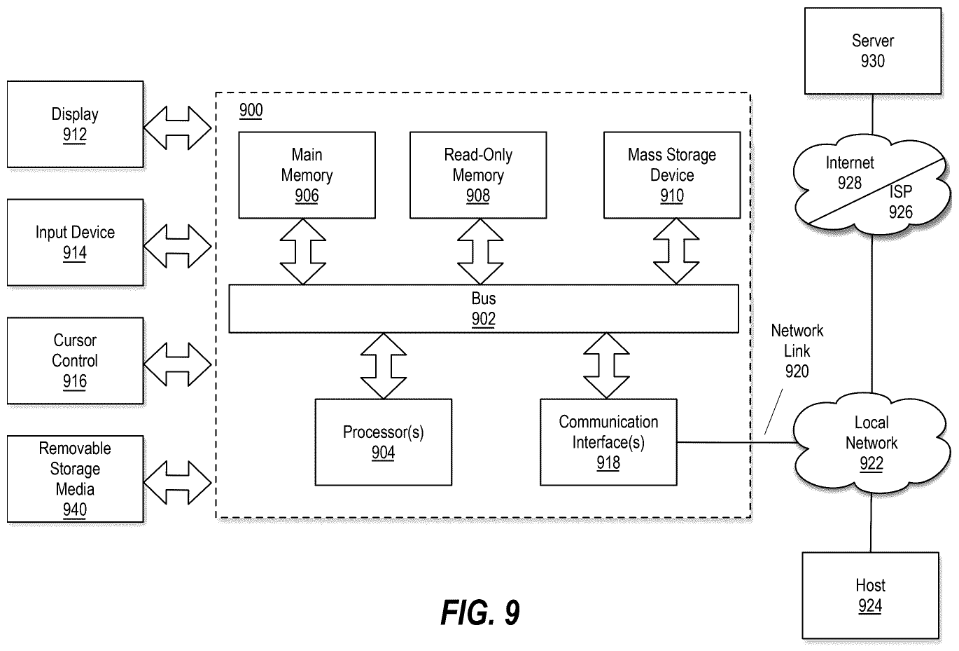

The various layers and processing described herein, may be implemented in the form of executable instructions stored on a machine readable medium and executed by a processing resource (e.g., a microcontroller, a microprocessor, central processing unit core(s), an application-specific integrated circuit (ASIC), a field programmable gate array (FPGA), and the like) and/or in the form of other types of electronic circuitry. For example, the processing may be performed by one or more virtual or physical computer systems of various forms (e.g., servers, blades, network storage systems or appliances, and storage arrays, such as the computer system described with reference to FIG. 9 below.

### Example Host

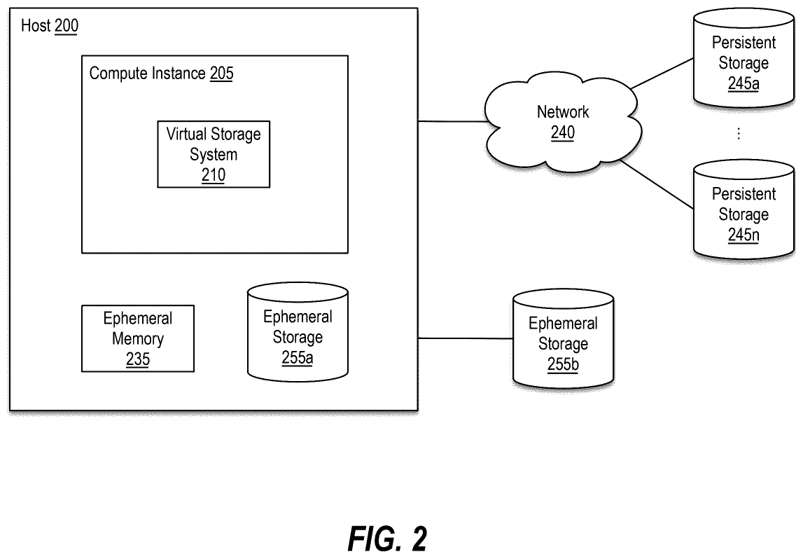

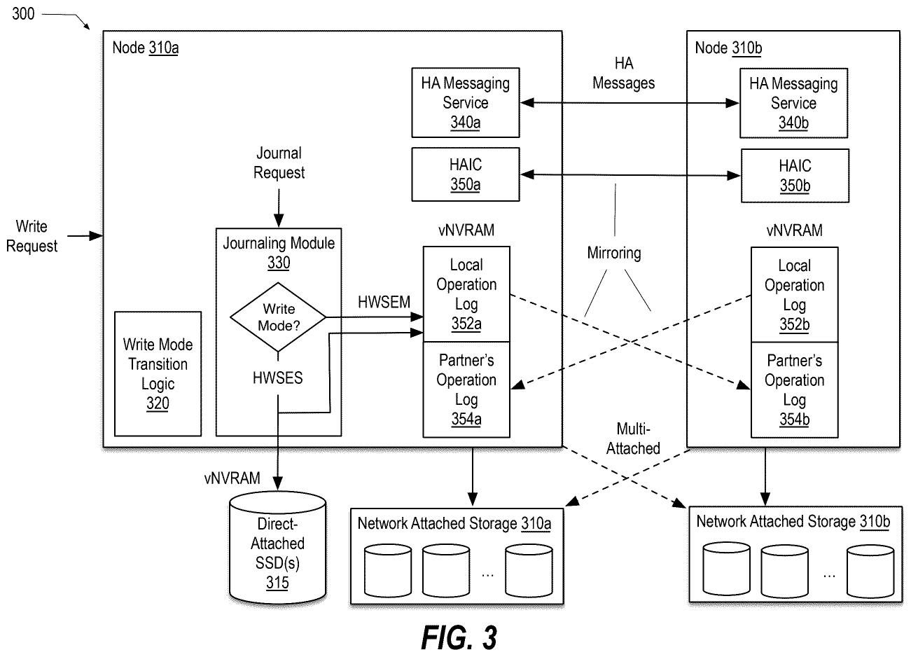

FIG. 2 is a block diagram conceptually illustrating a host 200 of a cloud environment in accordance with an embodiment of the present disclosure. In the context of the present example, host 200 may represent a physical host (e.g., a server computer system) on which a compute instance 205 (e.g., a container or a VM) may be run in a cloud environment provided by a cloud service provider (e.g., hyperscaler 120). As described further below with reference to FIG. 3, in one embodiment, a virtual storage system 210 (which may be analogous to one of virtual storage systems 110a-c) may include HA condition/state detection logic (not shown) to determine the HA status of an HA pair of which it is a part. The virtual storage system 210 may also include write mode transition logic (not shown) to perform journal swapping responsive to a change in the HA status from HA to HA degraded and vice versa. For example, in one embodiment, the virtual storage system 210 may perform write journaling to ephemeral memory 235 (e.g., a portion of system memory of the host 220 available for use by the compute instance 205) when the HA status of the HA pair indicates the HA pair is operating in a normal HA state and may perform write journaling to ephemeral storage (e.g., ephemeral storage 255a-b) associated with the compute instance 205 or persistent storage (e.g., persistent storage 245a-n) when the HA status indicates the HA pair is operating in an HA degraded state.

Ephemeral storage may represent direct-attached-storage (DAS) to host 200 in the form of one or more internal or local (e.g., ephemeral storage 255a) and/or external (e.g., ephemeral storage 255b) storage devices, such as HDDs and/or SSDs, to host 200. In the context of the present example, ephemeral storage is directly attached to host 200 through a physical host interface (e.g., SCSI, SATA, or SAS)). That is, the ephemeral storage is not networked and traffic exchanged between the host 200 and the ephemeral storage does not pass through any intermediate network devices associated with the cloud environment.

Persistent storage may represent one or more network attached hyperscale disks representing HDDs and/or SSDs (e.g., in the form of a block storage service, such as AWS EBS) that are indirectly attached to the host 200 via a network (e.g., network 240) within the cloud environment.

### Example HA Pair

FIG. 3 is a high-level conceptual block diagram illustrating an HA pair 300 in accordance with an embodiment of the present disclosure. The HA pair 300 (which in the context of the present example is assumed to be in a Single-AZ HA Configuration) may be part of a larger cluster of nodes (not shown) representing a distributed storage system or the HA pair 300 may represent the entirety of all nodes of a cluster representing a distributed storage system. In this example, a first node (node 310a), which may be analogous to one of virtual storage systems 110a-n or 210 and which may represent the primary node of the HA pair, is shown including a journaling module 330, an HA messaging service 340a, an HA interconnect (HAIC) 350a, write mode transition logic 320, a local operation log 352a, and a partner's operation log 354a. While it is to be appreciated, a second node (node 310b), which may be analogous to one of virtual storage systems 110a-n or 210 and which may represent the secondary node of the HA pair will generally have corresponding components to those shown for the first node, for sake of simplicity some of the corresponding components have intentionally been omitted and only a subset of the corresponding components (e.g., HA messaging service 340b, HAIC 350b, local operation log 352b, and partner's operation log 354b) are depicted.

As shown, each of the first node and the second node are coupled to respective network-attached storage 310a-b (which may be used for persisting data on behalf of clients (e.g., clients 105). The network-attached storage 310a-b may be multi-attached to allow a surviving node (e.g., node 310b) to takeover for a failed node (e.g., node 310a), for example, by taking over responsibility for serving access requests associated with network-attached storage 310a until the failed node recovers. This takeover process may also be referred to herein as a failover process. Similarly, when the failed node recovers and is able to resume participation in HA operations by among other things, reestablishing its mirroring interfaces (e.g., HAIC 350a) for receiving mirrored operation log data (e.g., user data and log metadata) from the HA partner and sending mirrored operation log data to the HA partner, the surviving node may perform a giveback of control over network-attached storage 310a and responsibility for handling storage access requests relating thereto to the recovered failed node. This giveback process may also be referred to herein as a failback process.

The journaling module 330, which may be part of a file system layer (e.g., file system layer 111) of the first node may be responsible for one or more of establishing one of multiple potential backing stores for vNVRAM, establishing a default write mode, and handling journal requests based on the current write mode. In various examples described herein, the write mode may be one of two high write speed (HWS) write modes (i.e., HWS ephemeral memory (HWSEM) or HWS ephemeral storage (HWSES)). When the write mode is HWS ephemeral memory, vNVRAM may be backed by system memory or a portion thereof (e.g., ephemeral memory 235) and journaling requests may involve performing write journaling to memory. When the write mode is HWS ephemeral storage, vNVRAM may be backed by a directed-attached NVMe SSD (e.g., one of one or more direct-attached SSDs) or EBS (e.g., ephemeral storage 255a or persistent storage 245a-n) and journaling requests may involve performing write journaling to one or both of memory and direct-attached NVMe SSD, which in some examples may be a local SSD of the host on which the first node is operable. So, in effect, there may be multiple versions of vNVRAM, for example, one version backed by ephemeral storage and one backed by ephemeral memory.

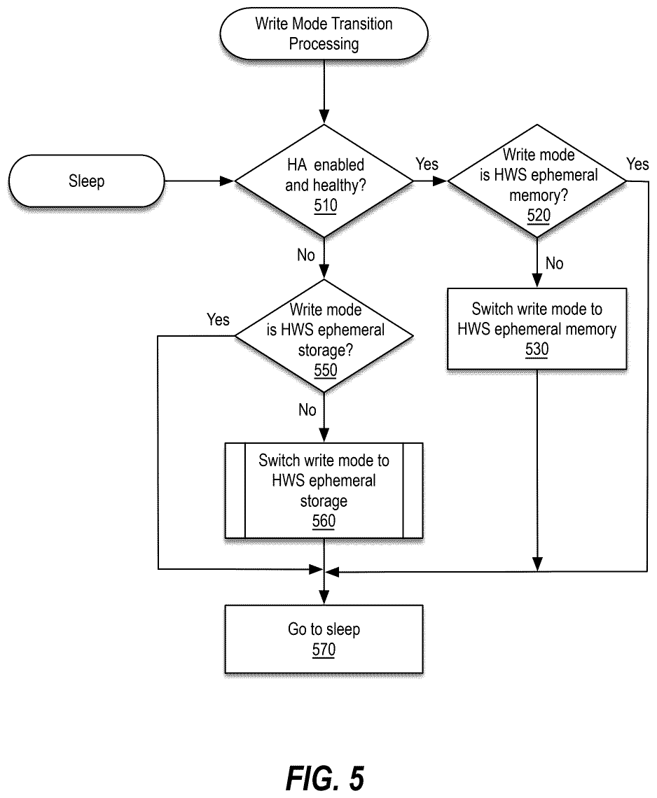

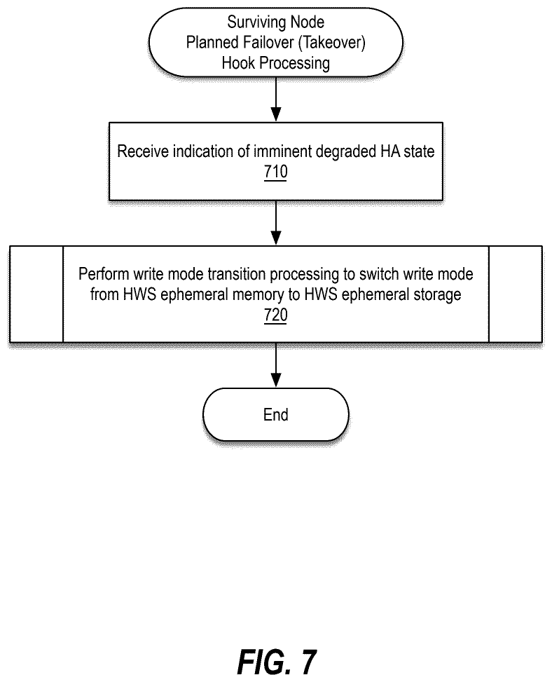

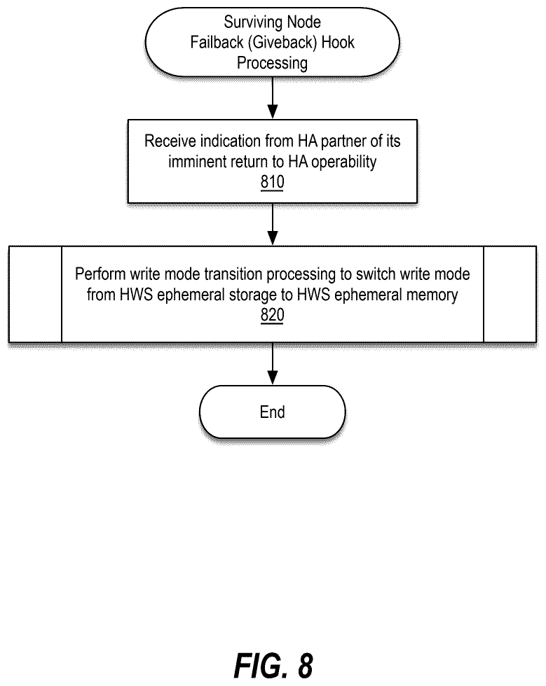

The respective HA messaging services (e.g., HA messaging services 340a-b) may be responsible for communicating information (e.g., HA messages) regarding various HA events and/or various HA state transitions from one HA partner to the other. As described further below with reference to FIGS. 7-8, those HA events and/or HA state transitions indicative of HA being enabled/disabled and healthy/unhealthy may be hooked by the write mode transition logic 320 to trigger switching, as appropriate, from one write mode to another. For instance, as described with reference to FIG. 5, when HA is or will imminently be in a degraded state (e.g., HA is not enabled or unhealthy), for example, as indicated by monitoring of messages received via the HA messaging services and potentially performance of one or more checks relating to the status of various components involved in HA operations, write mode transition logic 320 may cause the write mode to transition accordingly. For example, when the HA state changes from HA operations to HA degraded or when mirroring is inactive, the write mode may transition from the HWS ephemeral memory write mode to the HWS ephemeral storage write mode and when the HA state changes from HA degraded to HA operational or when mirroring is active, the write mode may transition from the HSW ephemeral storage write mode to the HWS ephemeral memory write mode.

The respective HAICs (e.g., HAIC 350a-b) may provide one or more communication channels through which mirroring (e.g., copying of operation log data, including user data and log metadata) is performed. The HAICs may represent physical or virtual network interface cards (NICs). In one embodiment, mirroring may be considered inactive (and hence the HA state of the HA pair may be considered degraded) when either or both of the HAICs are offline. Similarly, in one embodiment, mirroring may be considered active when both of the HAICs are online. The HA state of the HA pair may be considered operational when mirroring is active and there are no other indicators of a degraded state of HA operations, for example, the HA messaging services are both operational.

As one non-limiting concrete example, the first node may initially perform RAM journaling by default once both the first node and second node have successfully started up and HA is enabled and healthy. Then, when the second node is in maintenance or when throughput scaling is initiated, journal swapping may be performed to swap the journaling to a temporary EBS volume. If an EBS volume cannot be attached or secured (e.g., due to insufficient capacity, or insufficient free attachment slots), then the journaling may be instead switched to NVMe journaling, for example, by disabling some portion of NVMe read caching (e.g., disabling the external cache or victim cache), and repurposing one direct-attached ephemeral storage device for the journal. Upon completion of the maintenance/throughput scaling, the first node may switch back to RAM journaling and (i) delete the temporary EBS volume, if EBS journaling was employed; or (b) rebuild the NVMe cache and reenable it, if NVMe journaling was employed. In other embodiments, read caching and ephemeral storage journaling may share the same ephemeral storage device, for example, by partitioning the storage space among the two distinct functions.

When journaling is performed to ephemeral memory, the journaling module 330 may make use of a portion of ephemeral memory (the local operation log 352a), which is mirrored to a corresponding portion of ephemeral memory (i.e., the partner's operation log 354b) on the HA partner. As such, when HA is enabled and healthy, faster journaling can be performed while also being protected by the mirror copy on the HA partner. When journaling is performed to ephemeral storage (e.g., one of direct-attached SSD(s)), the journaling is higher latency but durability is enhanced by persistence of the operation log to a storage device that will remain accessible to the virtual storage system node at issue after a recoverable host error assuming the compute instance is brought back up by the hyperscaler on the same host after resolution of the error. Embodiments described herein, generally seek to operate the file system of the virtual storage system at issue in a more performant configuration most of the time during which both virtual storage systems of the HA pair are active and in a healthy HA operational state. At the same time, embodiments described herein, allow the file system to swap to a less performant but more resilient configuration during scheduled maintenance and throughput scaling in which one of the virtual storage systems is inactive.

While the present example is illustrative of a shared HA configuration, those skilled in the art will appreciate the methodologies described herein are equally applicable to non-shared HA configurations, for example, in which the nodes of an HA pair do not share storage and instead data is synchronously mirrored between the nodes.

### Example Journaling Module Initialization Processing

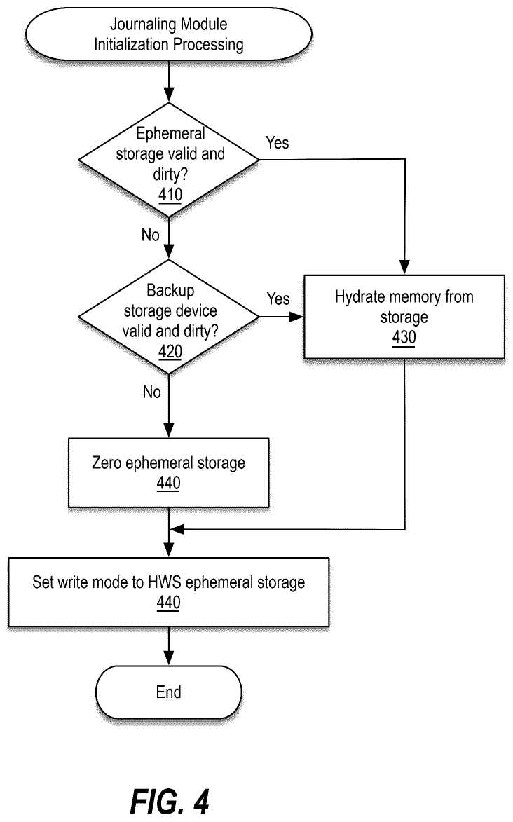

FIG. 4 is a flow diagram illustrating operations for performing journaling module initialization in accordance with an embodiment of the present disclosure. The processing described with reference to FIG. 4 may be performed by a file system (e.g., file system layer 111) of a virtual storage system (e.g., one of virtual storage systems 110a-n or one of nodes 310a-b) that is part of an HA pair. In some examples, the HA pair is operating in a Single-AZ HA Configuration. As noted above, in one embodiment, there are two write modes for handling journal requests relating to write requests received by the virtual storage system, including (i) a HWS ephemeral memory write mode in which journaling is performed to vNVRAM, which is backed by ephemeral memory (e.g., ephemeral memory 235) and (ii) a HWS ephemeral storage write mode in which journaling is performed to vNVRAM, which is backed by ephemeral storage (e.g., ephemeral storage 255a or 255b) representing directed-attached storage (e.g., direct-attached SSDs 315). Journal module initialization processing may be performed each time the virtual storage system boots.

At decision block 410, a determination is made regarding whether ephemeral storage (e.g., a first ephemeral storage device, such as ephemeral storage 255a or 255b or direct-attached SSD(s) 315) is valid and dirty. If so, processing branches to block 430; otherwise, processing continues with decision block 420.

At decision block 420, a determination is made regarding whether a backup storage device (e.g., a second ephemeral storage device, such as ephemeral storage 255a or 255b or direct-attached SSD(s) 315) is valid and dirty. If so, processing branches to block 430; otherwise, processing continues with block 440.

At block 430, ephemeral memory (e.g., ephemeral memory 235) is hydrated from the ephemeral storage determined at decision block 410 or 420 to be valid and dirty. For example, data from the ephemeral storage device at issue is loaded into ephemeral memory.

At block 440, ephemeral storage is zeroed. For example, the contents of the ephemeral storage may be overwritten with a pattern of all zeros with a “zero-fill” process, which may involve one or more passes of overwriting with zeros. Those skilled in the art will appreciate there are other ways of effectively erasing information from storage. For example, a combination of zeros and random data may be used or random data may be written in a first pass followed by one or more passes of overwriting with zeroes.

At block 450, the write mode for journaling is set to HWS ephemeral storage. As such, in the context of the present example, each virtual storage system of the HA pair starts off in the HWS ephemeral storage write mode and remains in the HWS ephemeral storage write mode until HA is enabled and healthy. In one embodiment, the virtual storage systems of the HA pair transition from one write mode to the other based on receipt of an event and subsequent evaluation of HA state information as described with reference to FIG. 5.

### Example Write Mode Transition

FIG. 5 is a flow diagram illustrating operations for performing a write mode transition in accordance with an embodiment of the present disclosure. The processing described with reference to FIG. 5 may be performed by a file system (e.g., file system layer 111) of a virtual storage system (e.g., one of virtual storage systems 110a-n or one of nodes 310a-b) that is part of an HA pair. In some examples, the HA pair is operating in a Single-AZ HA Configuration. As noted above, in one embodiment, there are two write modes for handling journal requests relating to write requests received by the virtual storage system, including (i) a HWS ephemeral memory write mode in which journaling is performed to vNVRAM, which is backed by ephemeral memory (e.g., ephemeral memory 235) and (ii) a HWS ephemeral storage write mode in which journaling is performed to vNVRAM, which is backed by ephemeral storage (e.g., ephemeral storage 255a or 255b) representing directed-attached storage (e.g., direct-attached SSDs 315). As a result, in some examples, switching from one write mode to the other changes the backing storage used by an vNVRAM subsystem (which may be referred to herein as a journaling module (e.g., journaling module 330)). Notably, in other examples, in order to facilitate efficient switching from the HWS ephemeral storage write mode to the HWS ephemeral memory write mode, journaling performed while, in the HWS ephemeral storage write mode may be performed to both ephemeral storage and ephemeral memory.

At decision block 510, a determination is made regarding whether HA is enabled and healthy as between the HA pair. If so, then processing continues with decision block 520. As mentioned above and as described further below, in some examples, the determination regarding whether HA is enabled and healthy may be based on monitoring of or hooks included within an HA message service (e.g., HA message service 340a) of the virtual storage system and may further include performing one or more checks to determine the HA state of the HA pair, for example, to evaluate the state of one or more components (e.g., HAICs 350a-b) involved in HA operations.

At decision block 520, a determination is made regarding whether the current write mode is appropriate for the HA state determined in decision block 510. In this case, when HA is enabled and healthy, the write mode should be HWS ephemeral memory. If the write mode is HWS ephemeral memory, then processing loops back to decision block 510; otherwise, processing continues with block 530.

At block 530, the write mode is switched to HWS ephemeral memory. This switch may involve updating a write mode state that is used by the journaling module to selectively perform the appropriate journaling (e.g., in-memory journaling vs. ephemeral storage journaling).

At decision block 550, a determination is made regarding whether the current write mode is appropriate for the HA state determined in decision block 510. In this case, when HA is either not enabled or not healthy, the write mode should be HWS ephemeral storage. If the write mode is HWS ephemeral storage, then processing branches to block 570; otherwise, processing continues with block 560.

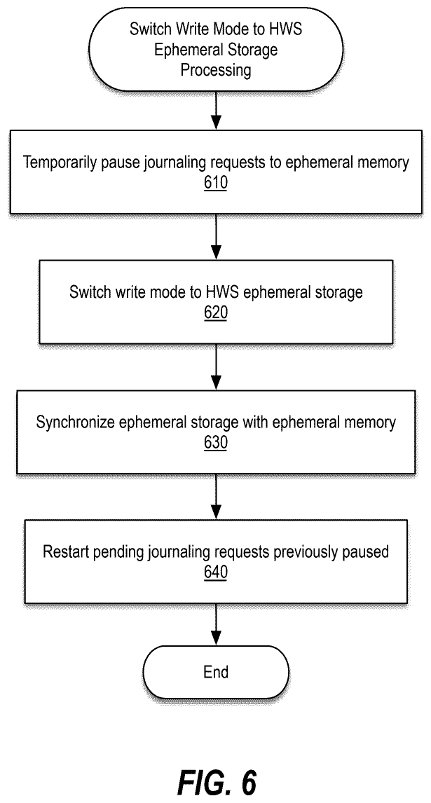

At block 560, the write mode is switched to HWS ephemeral storage. In some embodiments, switching the write mode from HWS ephemeral memory to HWS ephemeral storage involves temporarily quiescing journaling requests as described further below with reference to FIG. 6.

At block 570, the write mode transition processing thread goes to sleep. For example, the write mode transition processing thread may sleep until an event is received indicative of a potential need to change the write mode. Non-limiting examples of events that may trigger or awaken the write mode transition processing include a panic (e.g., a VM panic or kernel panic), an indication that a mirroring state change has occurred (e.g., mirroring has become active or inactive or an HAIC (e.g., HAIC 250a or 250b) has changed from online to offline or vice versa), and/or other indications that a failover or failback is imminent (e.g., a planned event, such as scheduled maintenance and/or throughput scaling is impending or ending). Those skilled in the art will recognize other examples of events that should trigger write mode transition processing. For example, in a shared HA configuration in which the nodes of an HA pair share storage, the lack of visibility to the shared storage (or observation of a storage device or disk inventory mismatch) by a given node of the HA pair represents yet another indication that HA is unhealthy and that may cause write mode transition processing to be performed. In general, anytime the cluster is not healthy and one of the HA partners is incapable of taking over for the other represents a scenario in which write mode transition processing should be performed.

In one embodiment, HA events and/or HA state transitions indicative of HA being enabled/disabled and/or healthy/unhealthy may be hooked by write mode transition logic (e.g., write mode transition logic 320), which may in term post an event to awaken the write mode transition processing thread.

### Example Write Mode Switching From Ephemeral Memory to Ephemeral Storage

FIG. 6 is a flow diagram illustrating operations for switching a write mode from HWS ephemeral memory to HWS ephemeral storage in accordance with an embodiment of the present disclosure. The processing described with reference to FIG. 6 may be performed by a file system (e.g., file system layer 111) of a virtual storage system (e.g., one of virtual storage systems 110a-n or one of nodes 310a-b) that is part of an HA pair. In one embodiment, the processing described with reference to FIG. 6 is performed as part of block 560 of FIG. 5.

At block 610, journaling requests to ephemeral memory are temporarily paused. For example, a journaling module (e.g., journaling module 330) may temporarily park journaling requests, on an existing least recently used (LRU) list and mark the new journaling requests as “pending” to identify them as yet to be copied to the in-memory version of vNVRAM. In one embodiment, copying of these pending journaling requests to ephemeral memory and flushing of these pending journaling requests to persistent storage is delayed until the write mode transition completes, for example, at block 650.

At block 620, the write mode is switched to HWS ephemeral storage. This switch may involve updating a write mode state that is used by the journaling module to selectively perform the appropriate journaling (e.g., in-memory journaling vs. ephemeral storage journaling).

At block 630, ephemeral storage is synchronized with ephemeral memory to bring the operation log data stored within ephemeral storage in sync with the operation log data currently present in ephemeral memory.

At block 640, after the synchronization of block 630 has been completed, the pending journaling requests previously temporarily paused in block 610 may be restarted. For example, the journaling module may be signaled to restart all pending journaling requests. In one embodiment, this may be accomplished by walking the existing journaling request LRU list and allowing those of the previously paused journaling requests (due to the write mode transition) to now be allowed to run to completion based on the current write mode.

As noted above, in some examples, when the write mode is HWS ephemeral storage, journaling continues to concurrently be performed to ephemeral memory, for example, as illustrated in FIG. 3. As a result, when switching from HWS ephemeral memory write mode to HWS ephemeral storage write mode, a synchronization similar to that described above in block 630 but from ephemeral storage to ephemeral memory need not be performed, thereby making the switch from HWS ephemeral memory write mode to HWS ephemeral storage write mode more efficient.

### Example HA Message Service Hooking

FIG. 7 is a flow diagram illustrating operations associated with a planned failover (takeover) hook included an HA messaging service in accordance with an embodiment of the present disclosure. The processing described with reference to FIG. 7 may be performed by an HA messaging layer (e.g., HA message services 340a-b) of each virtual storage system (e.g., a pair of virtual storage systems 110a-n or nodes 310a-b) that is part of an HA pair. In the context of the present example, various indications of imminent degraded HA state as indicated by messages received via the HA messaging layer from the HA partner (and potentially one or more checks of the status of components involved in HA operations) may trigger appropriate write mode transition processing, for example, in parallel with other failover (takeover) processing, which may be performed by other subsystems. For example, in one embodiment, the surviving node of an HA pair is transitioned to the HWS ephemeral storage write mode prior to taking control over the HA partner's persistent storage for client data (e.g., network-attached storage 310a or 310b).

At block 710, the HA messaging layer of the node at issue, which may be operating in a role of a primary node or a secondary node of an HA pair, receives an indication of imminent degraded HA state. According to one embodiment, a predetermined or configurable HA message of multiple existing HA messages for managing various events (e.g., relocation or control over the HA partner's persistent storage for client data) may be used as the indication of imminent degraded HA state.

At block 720, when the predetermined or configurable HA message is observed by the HA messaging layer, the hook causes a call to be made to write mode transition logic (e.g., write mode transition logic 320) to cause write mode transition processing to be performed to switch the write mode from HWS ephemeral memory to HWS ephemeral storage. In one embodiment, the performance of write mode transition processing is as described above in connection with FIG. 5.

FIG. 8 is a flow diagram illustrating operations associated with a failback (giveback) hook included an HA messaging service in accordance with an embodiment of the present disclosure. The processing described with reference to FIG. 8 may be performed by an HA messaging layer (e.g., HA message services 340a-b) of each virtual storage system (e.g., a pair of virtual storage systems 110a-n or nodes 310a-b) that is part of an HA pair. In the context of the present example, various indications of HA state as indicated by messages received via the HA messaging layer from the recovering HA partner may trigger appropriate write mode transition processing, for example, in parallel with other failback (giveback) processing, which may be performed by other subsystems. For example, in one embodiment, the surviving node of an HA pair is transitioned to the HWS ephemeral memory write mode prior to giving back control to the recovering HA partner its persistent storage for client data (e.g., network-attached storage 310a or 310b).

At block 810, the HA messaging layer of the surviving node of the HA pair, receives an indication that the recovering HA partner (for which the surviving node previously took over for) will imminently return to HA operability. According to one embodiment, a predetermined or configurable HA message of potentially multiple existing HA messages relating to the remote mirror reestablishment path, for example, used to, among other things, communicate to the surviving node that one or more of the mirroring interfaces of the recovering HA partner are in the process of being reestablished may be used as the indication of imminent return to HA operability by the recovering HA partner. As noted above with reference to FIG. 3, the mirroring interfaces (e.g., HAIC 350a or 350b) of the recovering HA partner may be used for (i) receiving operation log data (e.g., local operation log 352a or 352b) from the surviving node to maintain a local replica of the operation log data (e.g., partner's operation log 354b or 354a, respectively) and/or (ii) transferring operation log data (e.g., local operation log 352b or 352a) from the recovering HA partner to maintain a remote replica of the operation log data (e.g., partner's operation log 354a or 354b, respectively) on the surviving node.

At block 820, according to one embodiment, when the predetermined or configurable HA message is observed by the HA messaging layer, the hook causes a call to be made to write mode transition logic (e.g., write mode transition logic 320) to perform write mode transition processing to switch the write mode from HWS ephemeral storage to HWS ephemeral memory. In one embodiment, the performance of write mode transition processing is as described above in connection with FIG. 5.

While in the context of the flow diagrams of FIGS. 4-8 a number of enumerated blocks are included, it is to be understood that examples may include additional blocks before, after, and/or in between the enumerated blocks. Similarly, in some examples, one or more of the enumerated blocks may be omitted and/or performed in a different order.

### Considerations for Hosts Having a Single Ephemeral Storage Device

In some embodiments, the buffer cache make use of ephemeral storage of the host on which a given node is running. When a host has access to multiple ephemeral storage devices, one may be dedicated for use by the buffer cache and another may be used by the journaling module; however, when a host only has access to a single ephemeral storage device, the storage space of the single ephemeral storage device should be shared or portioned between the buffer cache and the journaling module. Alternatively, the buffer cache may simply be disabled in single ephemeral storage device host configurations when journal swapping is desired to be supported. While not necessary for implementing journal swapping as described herein, in one embodiment, the storage space of one or more ephemeral storage devices may be shared among multiple consumers by partitioning one or more namespaces of the one or more ephemeral storage devices as described in U.S. Pat. No. 12,189,972, which is hereby incorporated by reference in its entirety for all purposes.

### Example Computer System

Embodiments of the present disclosure include various steps, which have been described above. The steps may be performed by hardware components or may be embodied in machine-executable instructions, which may be used to cause one or more processing resources (e.g., one or more general-purpose or special-purpose processors) programmed with the instructions to perform the steps. Alternatively, depending upon the particular implementation, various steps may be performed by a combination of hardware, software, firmware and/or by human operators.

Embodiments of the present disclosure may be provided as a computer program product, which may include a non-transitory machine-readable storage medium embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more non-transitory machine-readable storage media containing the code according to embodiments of the present disclosure with appropriate special purpose or standard computer hardware to execute the code contained therein. An apparatus for practicing various embodiments of the present disclosure may involve one or more computers (e.g., physical and/or virtual servers) (or one or more processors within a single computer) and storage systems containing or having network access to computer program(s) coded in accordance with various methods described herein, and the method steps associated with embodiments of the present disclosure may be accomplished by modules, routines, subroutines, or subparts of a computer program product.

FIG. 9 is a block diagram that illustrates a computer system 900 in which or with which an embodiment of the present disclosure may be implemented. Computer system 900 may be representative of all or a portion of the computing resources of a physical host (e.g., host 200) on which a virtual storage system (e.g., one of virtual storage systems 110a-c or virtual storage system 210) of a distributed storage system is deployed. Notably, components of computer system 900 described herein are meant only to exemplify various possibilities. In no way should example computer system 900 limit the scope of the present disclosure. In the context of the present example, computer system 900 includes a bus 902 or other communication mechanism for communicating information, and one or more processing resources (e.g., hardware processor(s) 904) coupled with bus 902 for processing information. Hardware processor(s) 904 may be, for example, one or more general purpose microprocessors.

Computer system 900 also includes a main memory 906, such as a random access memory (RAM) or other dynamic storage device, coupled to bus 902 for storing information and instructions to be executed by processor 904. Main memory 906 also may be used for storing temporary variables or other intermediate information during execution of instructions to be executed by processor(s) 904. Such instructions, when stored in non-transitory storage media accessible to processor(s) 904, render computer system 900 into a special-purpose machine that is customized to perform the operations specified in the instructions.

Computer system 900 further includes a read only memory (ROM) 908 or other static storage device coupled to bus 902 for storing static information and instructions for processor(s) 904. A storage device 910, e.g., a magnetic disk, optical disk or flash disk (made of flash memory chips), is provided and coupled to bus 902 for storing information and instructions.

Computer system 900 may be coupled via bus 902 to a display 912, e.g., a cathode ray tube (CRT), Liquid Crystal Display (LCD), Organic Light-Emitting Diode Display (OLED), Digital Light Processing Display (DLP) or the like, for displaying information to a computer user. An input device 914, including alphanumeric and other keys, is coupled to bus 902 for communicating information and command selections to processor(s) 904. Another type of user input device is cursor control 916, such as a mouse, a trackball, a trackpad, or cursor direction keys for communicating direction information and command selections to processor(s) 904 and for controlling cursor movement on display 912. This input device typically has two degrees of freedom in two axes, a first axis (e.g., x) and a second axis (e.g., y), that allows the device to specify positions in a plane.

Removable storage media 940 can be any kind of external storage media, including, but not limited to, hard-drives, floppy drives, IOMEGA® Zip Drives, Compact Disc—Read Only Memory (CD-ROM), Compact Disc—Re-Writable (CD-RW), Digital Video Disk—Read Only Memory (DVD-ROM), USB flash drives and the like.

Computer system 900 may implement the techniques described herein using customized hard-wired logic, one or more ASICs or FPGAs, firmware or program logic which in combination with the computer system causes or programs computer system 900 to be a special-purpose machine. According to one embodiment, the techniques herein are performed by computer system 900 in response to processor(s) 904 executing one or more sequences of one or more instructions contained in main memory 906. Such instructions may be read into main memory 906 from another storage medium, such as storage device 910. Execution of the sequences of instructions contained in main memory 906 causes processor(s) 904 to perform the process steps described herein. In alternative embodiments, hard-wired circuitry may be used in place of or in combination with software instructions.

The term “storage media” as used herein refers to any non-transitory media that store data or instructions that cause a machine to operation in a specific fashion. Such storage media may comprise non-volatile media or volatile media. Non-volatile media includes, for example, optical, magnetic or flash disks, such as storage device 910. Volatile media includes dynamic memory, such as main memory 906. Common forms of storage media include, for example, a flexible disk, a hard disk, a solid state drive, a magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 902. Transmission media can also take the form of acoustic or light waves, such as those generated during radio-wave and infra-red data communications.

Various forms of media may be involved in carrying one or more sequences of one or more instructions to processor(s) 904 for execution. For example, the instructions may initially be carried on a magnetic disk or solid state drive of a remote computer. The remote computer can load the instructions into its dynamic memory and send the instructions over a telephone line using a modem. A modem local to computer system 900 can receive the data on the telephone line and use an infra-red transmitter to convert the data to an infra-red signal. An infra-red detector can receive the data carried in the infra-red signal and appropriate circuitry can place the data on bus 902. Bus 902 carries the data to main memory 906, from which processor(s) 904 retrieve and execute the instructions. The instructions received by main memory 906 may optionally be stored on storage device 910 either before or after execution by processor(s) 904.

Computer system 900 also includes a communication interface 918 coupled to bus 902. Communication interface 918 provides a two-way data communication coupling to a network link 920 that is connected to a local network 922. For example, communication interface 918 may be an integrated services digital network (ISDN) card, cable modem, satellite modem, or a modem to provide a data communication connection to a corresponding type of telephone line. As another example, communication interface 918 may be a local area network (LAN) card to provide a data communication connection to a compatible LAN. Wireless links may also be implemented. In any such implementation, communication interface 918 sends and receives electrical, electromagnetic or optical signals that carry digital data streams representing various types of information.

Network link 920 typically provides data communication through one or more networks to other data devices. For example, network link 920 may provide a connection through local network 922 to a host computer 924 or to data equipment operated by an Internet Service Provider (ISP) 926. ISP 926 in turn provides data communication services through the worldwide packet data communication network now commonly referred to as the “Internet”928. Local network 922 and Internet 928 both use electrical, electromagnetic or optical signals that carry digital data streams. The signals through the various networks and the signals on network link 920 and through communication interface 918, which carry the digital data to and from computer system 900, are example forms of transmission media.

Computer system 900 can send messages and receive data, including program code, through the network(s), network link 920 and communication interface 918. In the Internet example, a server 930 might transmit a requested code for an application program through Internet 928, ISP 926, local network 922 and communication interface 918. The received code may be executed by processor(s) 904 as it is received, or stored in storage device 910, or other non-volatile storage for later execution.

All examples and illustrative references are non-limiting and should not be used to limit the applicability of the proposed approach to specific implementations and examples described herein and their equivalents. For simplicity, reference numbers may be repeated between various examples. This repetition is for clarity only and does not dictate a relationship between the respective examples. Finally, in view of this disclosure, particular features described in relation to one aspect or example may be applied to other disclosed aspects or examples of the disclosure, even though not specifically shown in the drawings or described in the text.

The foregoing outlines features of several examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the examples introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method comprising:
receiving, by a surviving node of a high-availability (HA) pair of a plurality of nodes of a cluster of virtual storage systems, an indication of imminent return of a recovering HA partner of the surviving node to a healthy HA operational state; and
after said receiving, causing a file system of the surviving node to transition from a first write mode in which journaling is performed to ephemeral storage associated with a host on which the surviving node is running to a second write mode in which write journaling is performed to ephemeral memory of the host.

2. The method of claim 1, wherein the HA pair is operating in a single-availability zone (SAZ) HA configuration in which both the surviving node and an HA partner of the surviving node reside within a common availability zone of a hyperscaler.

3. The method of claim 1, wherein the indication of the imminent return to the healthy HA operational state is received at an HA messaging service of the surviving node from an HA messaging service of the HA partner.

4. The method of claim 3, wherein the indication of the imminent return to the healthy HA operational state comprises a message relating to restoration of journal mirroring.

5. The method of claim 1, wherein, in the first write mode, write journaling is also performed to ephemeral memory.

6. The method of claim 1, wherein the ephemeral storage comprises direct-attached storage in a form of a solid-state drive (SSD).

7. The method of claim 6, wherein the SSD comprises a local SSD that is internal to the host.

8. A non-transitory machine readable medium storing instructions, which when executed by one or more processing resources of a cluster of virtual storage systems cause the cluster to:
receive, by a surviving node of a high-availability (HA) pair of a plurality of nodes of the cluster, an indication of imminent return of a recovering HA partner of the surviving node to a healthy HA operational state; and
after receipt of the indication, causing a file system of the surviving node to transition from a first write mode in which journaling is performed to ephemeral storage associated with a host on which the surviving node is running to a second write mode in which write journaling is performed to ephemeral memory of the host.

9. The non-transitory machine readable medium of claim 8, wherein the indication of the imminent return to the healthy HA operational state is received at an HA messaging service of the surviving node from an HA messaging service of the HA partner.

10. The non-transitory machine readable medium of claim 9, wherein the indication of the imminent return to the healthy HA operational state comprises a message relating to restoration of journal mirroring.

11. The non-transitory machine readable medium of claim 8, wherein, in the first write mode, write journaling is also performed to ephemeral memory.

12. The non-transitory machine readable medium of claim 8, wherein the HA pair is operating in a single-availability zone (SAZ) HA configuration in which both the surviving node and an HA partner of the surviving node reside within a common availability zone of a hyperscaler.

13. The non-transitory machine readable medium of claim 8, wherein the ephemeral storage comprises direct-attached storage in a form of a solid-state drive (SSD).

14. The non-transitory machine readable medium of claim 13, wherein the SSD comprises a local SSD that is internal to the host.

15. A storage system comprising:
a high-availability (HA) pair of a plurality of nodes of a cluster of virtual storage systems each including and one or more processing resources; and
instructions that when executed by the one or more processing resources cause the storage system to:
receive, by a surviving node of the HA pair, an indication of imminent return of a recovering HA partner of the surviving node to a healthy HA operational state; and
after receipt of the indication, causing a file system of the surviving node to transition from a first write mode in which journaling is performed to ephemeral storage associated with a host on which the surviving node is running to a second write mode in which write journaling is performed to ephemeral memory of the host.

16. The storage system of claim 15, wherein the indication of the imminent return to the healthy HA operational state is received at an HA messaging service of the surviving node from an HA messaging service of the HA partner.

17. The storage system of claim 16, wherein the indication of the imminent return to the healthy HA operational state comprises a message relating to restoration of journal mirroring.

18. The storage system of claim 15, wherein, in the first write mode, write journaling is also performed to ephemeral memory.

19. The storage system of claim 15, wherein the HA pair is operating in a single-availability zone (SAZ) HA configuration in which both the surviving node and an HA partner of the surviving node reside within a common availability zone of a hyperscaler.

20. The storage system of claim 15, wherein the ephemeral storage comprises direct-attached storage in a form of a solid-state drive (SSD).
